(19) United States
(12) Patent Application Publication
(10) Pub. No.: US 2010/0170750 A1
(43) Pub. Date: Jul. 8, 2010

(54) LADDER AND A LADDER TREAD

(76) Inventor: Luhao Leng, Fujian (CN)

Correspondence Address: RABIN & Berdo, PC, 1101 14TH STREET, NW, SUITE 500, WASHINGTON, DC, 20005, US

(21) Appl. No.: 12/602,659

(22) PCT Filed: Jun. 25, 2008
(86) PCT No.: PCT/CN2008/071431

§ 371 Date: Dec. 2, 2009

(30) Foreign Application Priority Data
Jun. 29, 2007 (CN) 200720007518.3

(51) Int. Cl. E06C 7/08; E06C 7/50; E06C 1/02; E06C 1/16

(52) U.S. Cl. 182/219; 182/228.2

(57) ABSTRACT

A ladder includes legs (10, 20) and a tread (50). The ladder tread (50) is mounted between two legs (10, 20) and includes a plastic step (52) and a metal support bar (51). The plastic step (52) is supported and connected by the metal support bar (51).

### FIELD OF THE INVENTION

The present invention relates to a type of ladder and its ladder tread.

### BACKGROUND OF THE INVENTION

Conventional ladder tread has to satisfy two requirements of enough support strength and large enough area of surface. So far there are two kind of ladder tread, one of which is ladder tread of aluminium alloy, the other one of which is ladder tread of plastic. However, they both have shortages, for example because the ladder tread is made of aluminium alloy, the cost of it is too high; because the ladder tread is made of plastic, the plastic ladder tread is difficult to connected to legs of the ladder.

### SUMMARY OF THE INVENTION

The present invention supplies a type of ladder and its ladder tread, which could overcome the shortages of high manufacturing cost and difficulty of connection.

The technical solution applied by the present invention is:

A ladder tread comprises a plastic tread and a metal support bar which supports and connects the plastic tread to front legs.

In a preferred embodiment of the present invention, a fixing through groove is set up in the bottom of the plastic tread, in which the metal support bar is fixed.

In a preferred embodiment of the present invention, the two ends of the plastic tread extend outside and become decorations.

The technical solution applied by the present invention is:

A ladder comprises legs and a ladder tread which is laid out between front legs, and the ladder tread includes a plastic tread and a metal support bar that supports and connects the plastic tread to the front legs.

In a preferred embodiment of the present invention, a fixing through groove is set up in the bottom of the plastic tread, in which the metal support bar is fixed.

In a preferred embodiment of the present invention, the ladder tread is fixed to the front legs by the metal support bar.

In a preferred embodiment of the present invention, strengthening plates are fixed to the front legs, and the metal support bar is connected to the strengthening plates.

In a preferred embodiment of the present invention, the two ends of the plastic tread extend outside and become two decorations which cover the strengthening plates.

In a preferred embodiment of the present invention, two axial grooves are laid out in the front legs, and the two sides of each of the strengthening iron plates are stuck edges. The strengthening iron plates are both fixed to the front legs and cover part of it. Besides, the two stuck edges are respectively stuck in the two grooves.

In a preferred embodiment of the present invention, the strengthening plates are iron strengthening plates to which the metal support bar is welded.

In the ladder tread of the present invention, the plastic tread is supported and connected by the metal support bar, so the ladder tread not only satisfies the two requirements of enough support strength and large enough area of the surface, but also has the following advantages: 1 the manufacturing cost is reduced; 2. Owing to the connection between the metal support bar and the front legs, it is easy for the ladder tread to be connected to the legs and the connection strength is high. The metal is not directly fixed to the front legs but fixed to the front legs through the strengthening plates, so the present invention also has the following advantages: 1. The strengthening could disperse the pressure to metal support bar in order to protect and strengthen the legs; 2. Compared to conventional designs, the combination of the ladder tread and the front legs is more secure and more artistic. The iron strengthening plates cover part of the front legs and are fixed to them. The decorations cover the iron strengthening plates so as to make that the present invention looks neat and tidy.

### BRIEF DESCRIPTION OF THE DRAWINGS

FIG. 1 is a three-dimension exploded view of the ladder tread in a preferred embodiment of the present invention.

FIG. 2 is a three-dimension view of the ladder in a preferred embodiment of the present invention.

FIG. 3 is a three-dimension exploded view of the ladder in a preferred embodiment of the present invention.

FIG. 4 is a front view of the ladder in a preferred embodiment of the present invention.

FIG. 5 is a sectional view of the part A in FIG. 4.

FIG. 6 is a sectional view of the B-B line in FIG. 5.

FIG. 7 is a sectional enlarged view of part A in FIG. 4.

### DESCRIPTION OF MARKS IN THE DRAWINGS

front legs—10; rear legs—20; handrail—30; hinges—40; ladder tread—50; groove—11; iron strengthening plates—12; stuck edges—121; metal support bar—51; plastic tread—52; fixing through groove—53; decorations—54.

### DESCRIPTION OF SPECIFIC EMBODIMENTS

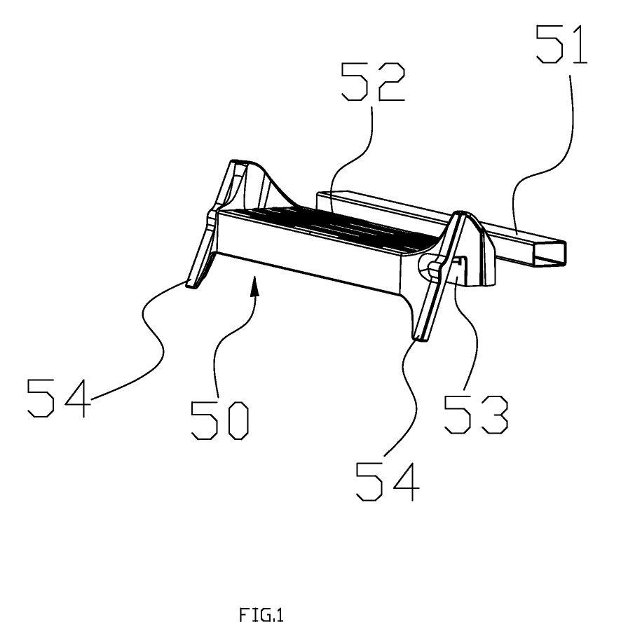

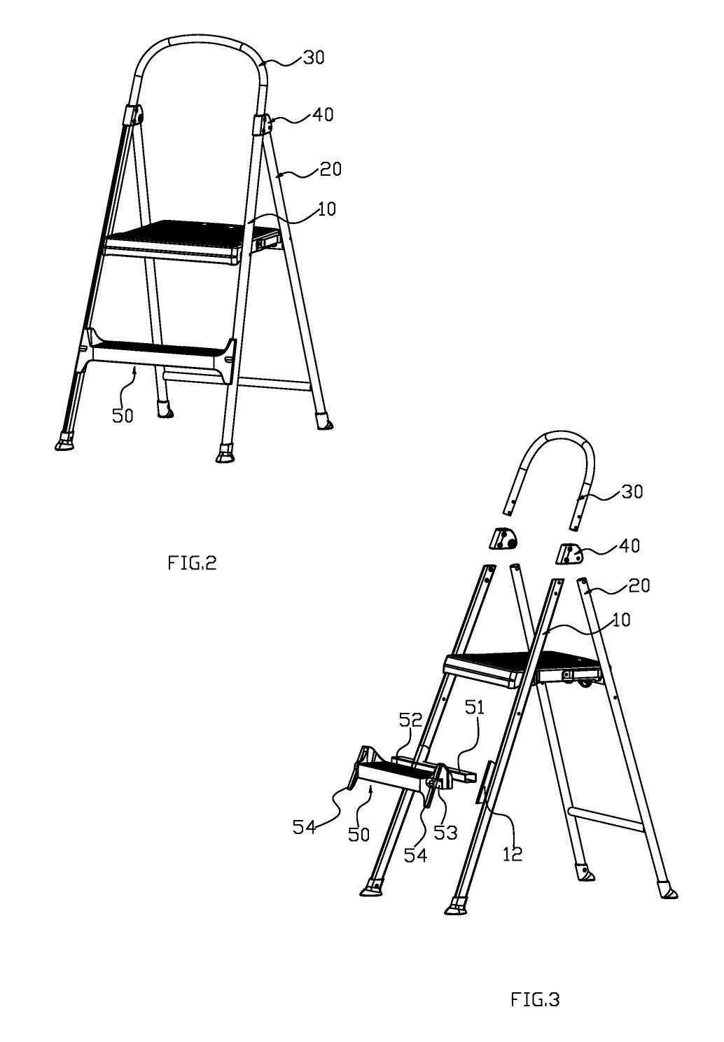

In a preferred embodiment of the present invention, referring to FIG. 1, the ladder tread 50 comprises a plastic tread 52 and a metal support bar 51, and a fixing through groove 53 is set up in the bottom of the plastic tread 52. Furthermore, the two ends of the plastic tread 52 respectively extend outwards, upwards and downwards into a decoration 54 perpendicular to the body of the plastic tread 52. The metal support bar 51 is fixed in the fixing through groove 53 so that it could be fixed to the plastic tread 52, and the length of the metal support bar 51 is no shorter than the length of the fixing through groove 53; In the embodiment, the metal support bar 51 is a rectangular parallelepiped (cuboid), and the shape of the fixing through groove 53, which is rectangular form, could match the metal support bar 51 in order to make sure that they could not rotate relative to each other.

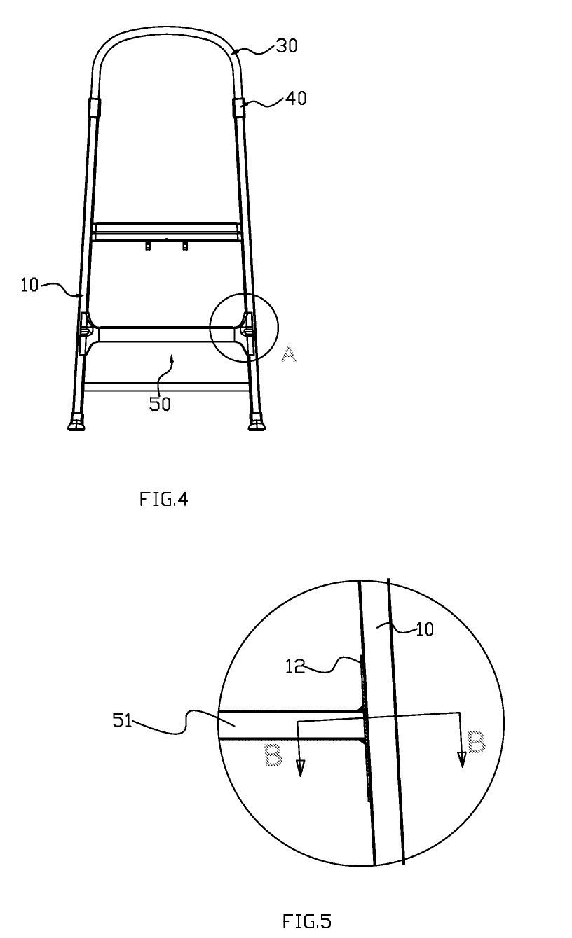

In another preferred embodiment of the present invention, referring to FIG. 1, FIG. 3 and FIG. 4, the ladder comprises two front legs 10, two rear legs 20, a handrail 30, a set of hinges 40 and a ladder tread 50. The two front legs 10, the rear legs 20 and the handrail 30 are all made from aluminium alloy; the ladder tread 50 is fixed between the two front legs 10; the handrail 30 and the front legs 10 are fixed together with the set of hinges 40, the rear legs 20 are rotatable connected to the set of hinges 40 in order to achieve the hinge connection between the front legs 10 and the rear legs 20.

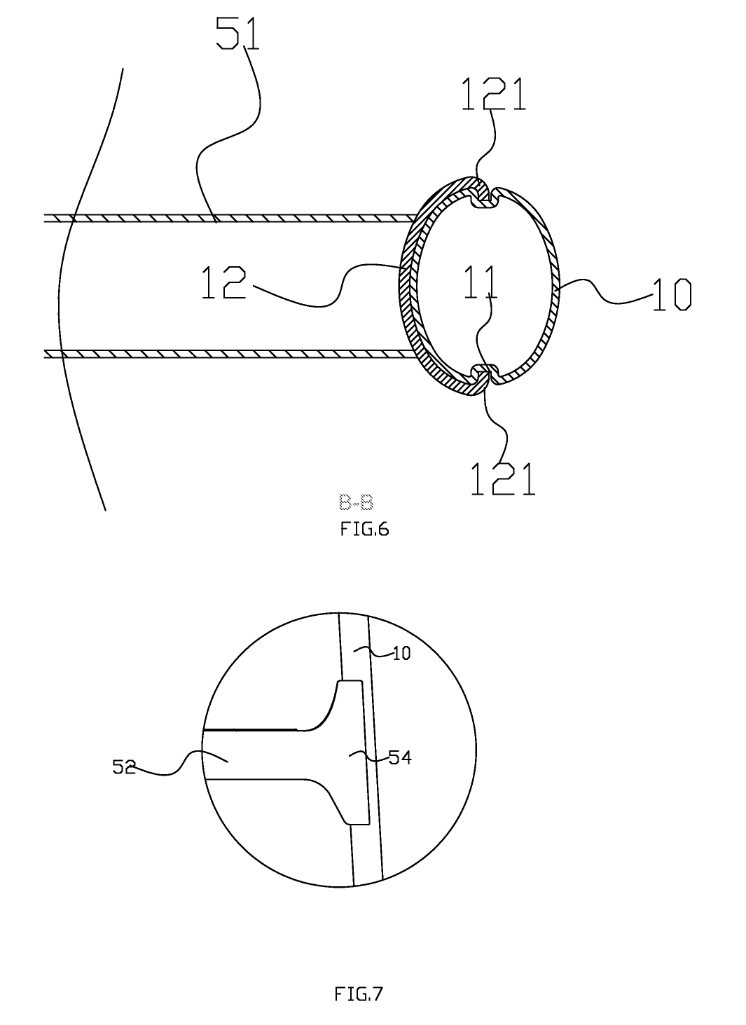

Referring to FIG. 5, FIG. 6, and FIG. 7, the front legs 10 are oval-shaped pipes, and two axial grooves are laid out in each front leg 10; two ends of the a iron strengthening plate 12 are made into stuck edges 121. Each iron strengthening plate 12 is fixed to a front leg 10 with two rivets, covering interior part of the front leg 10, and the two stuck edges 121 are respectively stuck in the two grooves 11.

The ladder tread 50 comprises a plastic tread 52, a metal support bar 51, and a fixing through groove 53 is set up in the bottom of the plastic tread 52. Furthermore, the two ends of the plastic tread 52 respectively extend outwards, upwards and downwards into a decoration 54. The metal support bar 51 is fixed in the fixing through groove 53, and the length of the metal support bar 51 is no shorter than the length of the fixing through groove 53 in order to prevent the end surface getting into the fixing through groove 53; the metal support bar 51 is a rectangular parallelepiped, and the shape of the fixing through groove 53, which is rectangular form, could match the metal support bar 51 in order to make sure that they could not rotate relative to each other.

The metal support bar 51 is welded to the iron strengthening plate 12, and the interior shape of the decorations 54 of the plastic tread 52 matches the exterior shape of the iron strengthening plates 12 in order that the decorations 54 could cover the iron strengthening plate 12 stuck in the front legs 10. As a result, the iron strengthening plates 12 could be decorated and the plastic tread could be stabilized, which make the ladder more secure and more artistic.

### INDUSTRIAL APPLICABILITY

In the present invention, the ladder tread comprises a metal support bar and a plastic tread, which has the advantages of rational design, superior security, convenience of manufacturing.

1. A type of the ladder tread comprises a plastic tread and a metal support bar which supports and connects the plastic tread to front legs.

2. The ladder tread according to claim 1, wherein a fixing through groove is set up in the bottom of the plastic tread, in which the metal support bar is fixed.

3. The ladder tread according to claim 1, wherein the two ends of the plastic tread extend outsides and become decorations.

4. A type of ladder comprising legs and a ladder tread which is laid out between front legs, wherein the ladder tread comprises a plastic tread and a metal support bar which supports and connects the plastic tread to the front legs.

5. The ladder according to claim 4, wherein a fixing through groove is set up in the bottom of the plastic tread, in which the metal support bar is fixed.

6. The ladder according to claim 5, wherein the ladder tread is fixed to the front legs by the metal support bar.

7. The ladder according to claim 4, wherein strengthening plates are fixed to the front legs respectively, and the metal support bar is connected to the strengthening plates.

8. The ladder according to claim 7, wherein the two ends of the plastic tread extend outsides and become two decorations which cover the strengthening plates.

9. The ladder according to claim 7, wherein two axial grooves are laid out in the front legs, and the two sides of each of the strengthening iron plates are stuck edges. The strengthening iron plates are both fixed to the front legs and cover part of it. Besides, the two stuck edges are respectively stuck in the two grooves.

10. The ladder according to claim 9, wherein he front legs are oval-shaped pipes, and two axial grooves are laid out in each front leg; two ends of the a iron strengthening plate are made into stuck edges. Each iron strengthening plate is fixed to a front leg with two rivets, covering interior part of the front leg, and the two stuck edges are respectively stuck in the two grooves.

11. The ladder according to claim 10, wherein the two ends of the plastic tread respectively extend outwards into a decoration perpendicular to the body of the plastic tread, and the interior shape of the decorations matches the exterior shape of the iron strengthening plates in order that the decorations could cover the iron strengthening plates stuck in the front legs.

12. The ladder tread according to claim 2, wherein the two ends of the plastic tread extend outsides and become decorations.

13. The ladder according to claim 5, wherein strengthening plates are fixed to the front legs respectively, and the metal support bar is connected to the strengthening plates.

14. The ladder according to claim 6, wherein strengthening plates are fixed to the front legs respectively, and the metal support bar is connected to the strengthening plates.

15. The ladder according to claim 13, wherein the two ends of the plastic tread extend outsides and become two decorations which cover the strengthening plates

16. The ladder according to claim 14, wherein the two ends of the plastic tread extend outsides and become two decorations which cover the strengthening plates

17. The ladder according to claim 13, wherein two axial grooves are laid out in the front legs, and the two sides of each of the strengthening iron plates are stuck edges. The strengthening iron plates are both fixed to the front legs and cover part of it. Besides, the two stuck edges are respectively stuck in the two grooves.

18. The ladder according to claim 14, wherein two axial grooves are laid out in the front legs, and the two sides of each of the strengthening iron plates are stuck edges. The strengthening iron plates are both fixed to the front legs and cover part of it. Besides, the two stuck edges are respectively stuck in the two grooves.

19. The ladder according to claim 17, wherein the front legs are oval-shaped pipes, and two axial grooves are laid out in each front leg; two ends of the a iron strengthening plate are made into stuck edges. Each iron strengthening plate is fixed to a front leg with two rivets, covering interior part of the front leg, and the two stuck edges are respectively stuck in the two grooves.

20. The ladder according to claim 18, wherein he front legs are oval-shaped pipes, and two axial grooves are laid out in each front leg; two ends of the a iron strengthening plate are made into stuck edges. Each iron strengthening plate is fixed to a front leg with two rivets, covering interior part of the front leg, and the two stuck edges are respectively stuck in the two grooves.

21. The ladder according to claim 19, wherein the two ends of the plastic tread respectively extend outwards into a decoration perpendicular to the body of the plastic tread, and the interior shape of the decorations matches the exterior shape of the iron strengthening plates in order that the decorations could cover the iron strengthening plates stuck in the front legs.

22. The ladder according to claim 20, wherein the two ends of the plastic tread respectively extend outwards into a decoration perpendicular to the body of the plastic tread, and the interior shape of the decorations matches the exterior shape of the iron strengthening plates in order that the decorations could cover the iron strengthening plates stuck in the front legs.
